(19) United States
(12) Patent Application Publication
(10) Pub. No.: US 2025/0192468 A1
(43) Pub. Date: Jun. 12, 2025

(54) MODULAR POWER POST ASSEMBLY WITH RECEPTACLE HOUSING

(71) Applicant: Hubbell Incorporated, Shelton, CT (US)

(72) Inventors: Stephen Michael Boener, Goshen, IN (US); Jonathan Randall Falls, Gilbert, AZ (US); Jace Robert Lee Matteson, Granger, IN (US)

(21) Appl. No.: 18/971,548

(22) Filed: Dec. 6, 2024

Related U.S. Application Data
(60) Provisional application No. 63/606,755, filed on Dec. 6, 2023.

(51) Int. Cl. H01R 13/516; H02G 1/08; H02G 9/00

(52) U.S. Cl. CPC H01R 13/516; H02G 1/08; H02G 9/00

(57) ABSTRACT

An outdoor mounting assembly for use with an electrical device such as an outlet. A post has a hollow body with an upper end and a lower end. A receptacle housing is removably connected to the upper end of the post. The receptacle housing has a top and a plurality of side walls defining an interior cavity. At least one of the side walls has an opening providing access to the interior cavity. A cover is moveably connected to the receptacle housing. The cover has an opening to permit passage of a conductor.

### FIELD

Various exemplary embodiments relate to mounting posts for external electrical devices, for example receptacle bollards or mounting posts used in landscapes, parking lots, docks, or other outdoor areas.

### BACKGROUND

Outdoor power receptacles can be used to provide temporary or semi-permanent power supply in outdoor locations. These outdoor receptacles can be elevated using bollards or mounting posts fixed at a given location. Power conductors can be run underground into the post and connected to the rear of the receptacle. The posts can provide a weather-proof housing for the receptacles.

### SUMMARY

Certain configurations are directed to a modular assembly of various components that can be used interchangeably to create different power post support structures.

In certain configurations, different mounting posts, including in-ground and surface mounting posts, optional extension posts, different receptacle housing configurations, and different cover configurations can be combined in different manners to obtain a power post assembly.

Certain configurations are directed to an outdoor mounting assembly for an electrical device. A post has a hollow body with an upper end and a lower end. A receptacle housing is removably connected to the upper end of the post. The receptacle housing has a top and a plurality of side walls defining an interior cavity. At least one of the side walls has an opening providing access to the interior cavity. A cover is moveably connected to the receptacle housing. The cover has an opening to permit passage of a conductor.

Certain configurations are directed to an outdoor mounting assembly for an electrical device including a post having a hollow body with an upper end and a lower end. A receptacle housing is removably connected to the upper end of the post. The receptacle housing has a top and a plurality of side walls defining an interior cavity. At least one of the side walls has an opening providing access to the interior cavity. A divider is removably positioned in the interior cavity of the receptacle housing to separate the interior cavity into a first compartment and a second compartment.

Certain configurations are directed to an outdoor mounting assembly for an electrical device. A post has a hollow body with an upper end and a lower end. The upper end of the post includes a first snap-fit connector. An extension member is connected to the post. The extension member has a second snap-fit connector mating with the first snap-fit connector and a third snap-fit connector. A receptacle housing is removably connected to the extension member. The receptacle housing has a top and a plurality of side walls defining an interior cavity. At least one of the side walls has an opening providing access to the interior cavity. The receptacle has a fourth snap-fit connector mating with the third snap-fit connector.

Certain configurations are directed to an outdoor mounting assembly for an electrical device. A post includes a body with an upper wall. The upper wall has one or more knockouts. A receptacle housing is removably connected to the upper end of the post. The receptacle housing has a top and a plurality of side walls defining an interior cavity. At least one of the side walls has an opening providing access to the interior cavity. A cover is moveably connected to the receptacle housing.

Certain configurations are directed to a method of connecting a receptacle to an outdoor mounting assembly. A post is positioned to receive a conduit containing a primary electrical conductor and to extend above a support surface. A receptacle is connected to a receptacle housing. A secondary electrical conductor is connected to the receptacle. The receptacle housing is positioned near the post and the primary electrical conductor is connected with the secondary electrical conductor. The receptacle housing is positioned on the post after connecting the primary electrical conductor with the secondary electrical conductor.

### BRIEF DESCRIPTION OF THE DRAWINGS

The aspects and features of various exemplary embodiments will be more apparent from the description of those exemplary embodiments taken with reference to the accompanying drawings.

FIG. 1 is a perspective view of an exemplary power post assembly.

FIG. 2 is a perspective view of the mounting post of FIG. 1.

FIG. 3 is a front view of the mounting post of FIG. 1.

FIG. 4 is a perspective view of the receptacle housing of FIG. 1.

FIG. 5 is a side, sectional view of the power post assembly of FIG. 1.

FIG. 6 is a partial, perspective view of the power post assembly of FIG. 1 with a cover.

FIG. 7 is a rear perspective view of the cover of FIG. 6.

FIG. 8 is a partial, side sectional view of a snap-fit connection between a post and a receptacle housing.

FIG. 9 is a perspective view of another exemplary receptacle housing and cover.

FIG. 10 is a perspective view of the receptacle housing of FIG. 9.

FIG. 11 is a side, sectional view of the receptacle housing and cover of FIG. 9 with a mounting post and showing an exemplary wire connection.

FIG. 12 is an exploded perspective view of a power post assembly with an extension.

FIG. 13 is a perspective view of another exemplary power post assembly.

FIG. 14 is a side, section view of the power post assembly of FIG. 13.

FIG. 15 is a perspective view of the mounting plate of FIG. 13.

FIG. 16 is a perspective view of another exemplary receptacle housing, cover, and extension.

FIG. 17 is a perspective view of the extension of FIG. 16.

FIG. 18 is a bottom perspective view of the extension of FIG. 17.

FIG. 19 is a perspective view of the receptacle housing of FIG. 16.

FIG. 20 is a rear perspective view of the cover of FIG. 16.

FIG. 21 is a perspective view of an exemplary mounting plate.

FIG. 22 is a side, sectional view of the assembly of FIG. 16 and the mounting plate of FIG. 21.

FIG. 23 is a perspective view of another exemplary receptacle housing.

FIG. 24 is a perspective view of the receptacle housing of FIG. 23 with a receptacle cover attached.

FIG. 25 is a perspective view of another exemplary receptacle housing.

FIG. 26 is a perspective view of the receptacle housing of FIG. 25 with receptacle covers attached.

FIG. 27 is a perspective view of another exemplary receptacle housing.

FIG. 28 is a perspective view of the receptacle housing of FIG. 27 with a receptacle cover attached.

FIG. 29 is a perspective view of another exemplary power post assembly.

FIG. 30 is a side view of the power post assembly of FIG. 29 with receptacle covers and receptacles attached.

FIG. 31 is a bottom perspective view of another exemplary receptacle housing.

FIG. 32 is a front perspective view of an exemplary divider.

FIG. 33 is a rear perspective view of the divider of FIG. 32

FIG. 34 is a bottom perspective view of the receptacle housing of FIG. 31 with the divider of FIG. 32.

FIG. 35 is a perspective view of an exemplary power post assembly.

FIG. 36 is a side, sectional view of FIG. 35.

FIG. 37 is a perspective view of an exemplary grounding assembly.

FIG. 38 is a perspective view of an exemplary divider.

FIG. 39 is a top perspective view of an exemplary surface mounting post.

FIG. 40 is a bottom perspective view of FIG. 39.

### DETAILED DESCRIPTION OF EXEMPLARY EMBODIMENTS

Certain aspects described herein are directed to a power post with a removable receptacle housing. Power posts are typically installed in outdoor areas and provide a weather resistant housing to a power receptacle. A two-piece assembly utilizing a separate, removable receptacle housing allows different types of receptacle housing to be attached to the post and also can allow for easy replacement of a damaged receptacle housing without having to remove the entire post. This configuration can also allow housings for other electrical devices to be connected to the post as needed. The post and receptacle housing can be made from a durable polymer material, such as PVC.

Additionally, the post can be configured to allow for easier connections of electrical devices. For example, the base of the post can be positioned in a proper location and a power line run through the base. The necessary conductors can be spliced or pigtailed together as needed outside of the base. A receptacle can be separately connected to the receptacle housing and conductors can be connected to the receptacle and extend into the housing. The conductors on the base and the conductors on the receptacle housing can then be easily connected together to provide power to the receptacle.

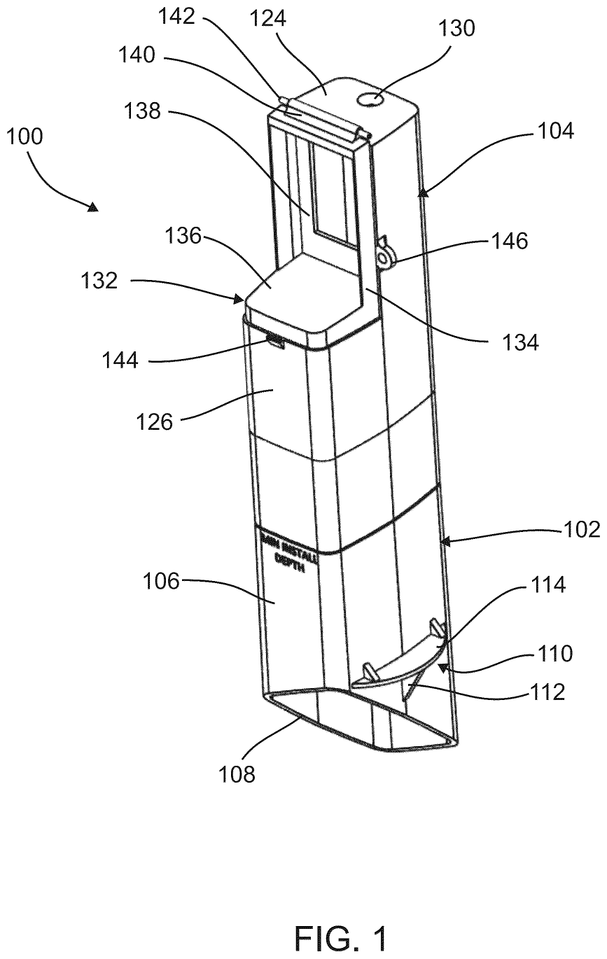

FIG. 1 show an exemplary configuration of a power post assembly 100 for an electrical device. The power post assembly 100 includes a mounting post 102 and a removable receptacle housing 104 connected to the mounting post 102. Other configurations can utilize different housings or different electrical devices, such as light fixtures, connected to the mounting post 102.

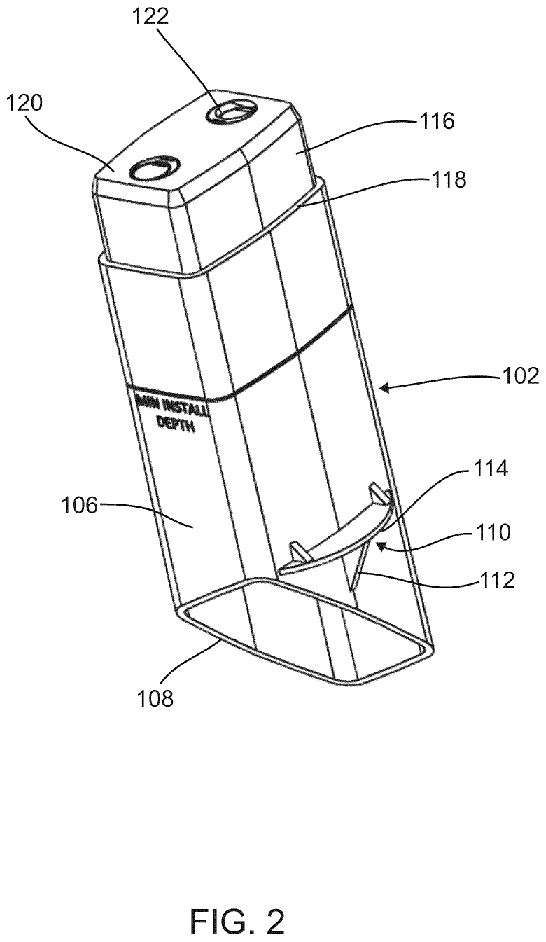

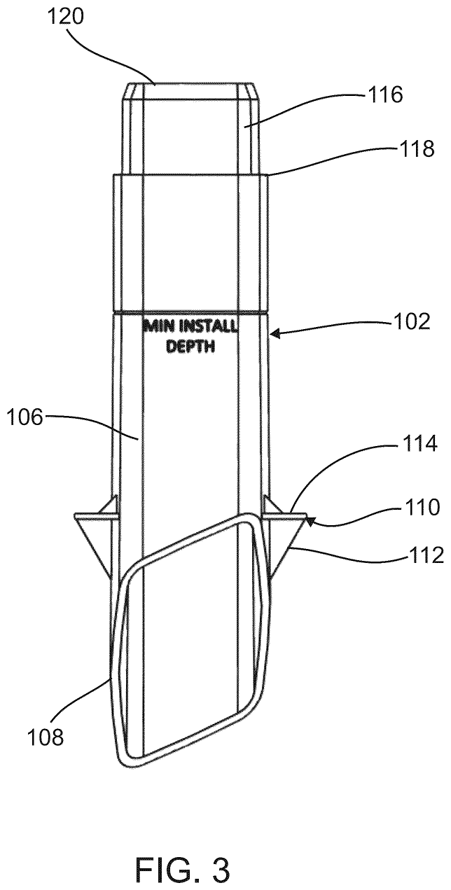

In certain configurations the post 102 is a ground-insertion post having a substantially hollow body 106 with a square shape having a lower end and an upper end as best shown in FIGS. 2 and 3. The lower end can have a truncated portion 108 that tapers to a point to help facilitate insertion of the post 102 into the ground. One or more stabilizer fins 110 can extend outwardly from the lower end. The stabilizer fins 110 can have a bottom portion 112 with a substantially triangular configuration and a curved upper flange 114. In other configurations different types of ground stabilizers can be used instead of, or in addition to, the stabilizer fins 110, or no stabilizers can be used. The fins 110 may be integrally connected to the body 106 (e.g., via molding, welding, etc.). In other examples, the fins 110 may be removably connected through an opening in the body 106 (e.g., via a snap fit, press fit, etc.). In still other examples, the fins 110 may be separate elements that are connected to one another around the body 106.

The upper end of the post 102 can include a housing receiving area defined by one or more outer walls 116 offset from the lower body 106. An edge 118 is formed between the lower body 106 and the upper end. The receptacle housing 104 can be received on the edge 118 so that an outer surface of the receptacle housing 104 is substantially flush with an outer surface of the lower body 106.

An upper wall 120 of the post 102 can include one or more knockouts 122 which can be removed to provide apertures through the upper end of the post 102. These apertures can be used for running conductors to make electrical connections in the receptacle housing 104. For example, a conduit containing one or more conductors can be positioned inside of the post 102 and run through an opening formed by removal of a knockout 122. The conduit can be held in place by a fastener positioned on the outside of the upper wall 120, for example a locking nut.

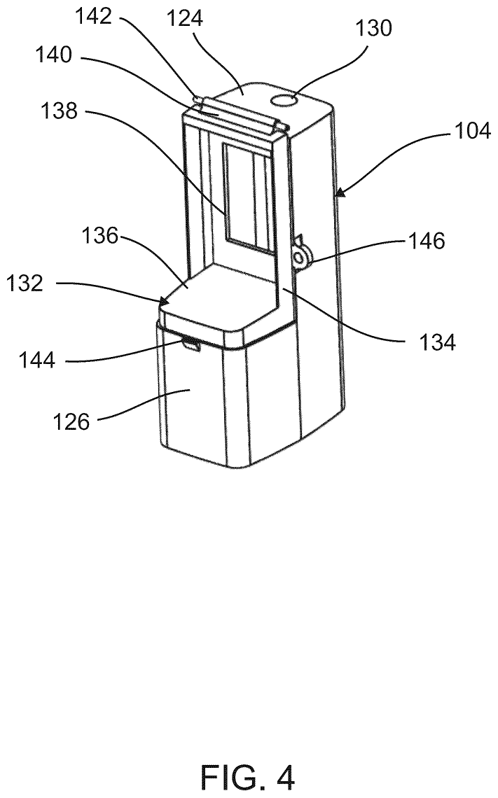

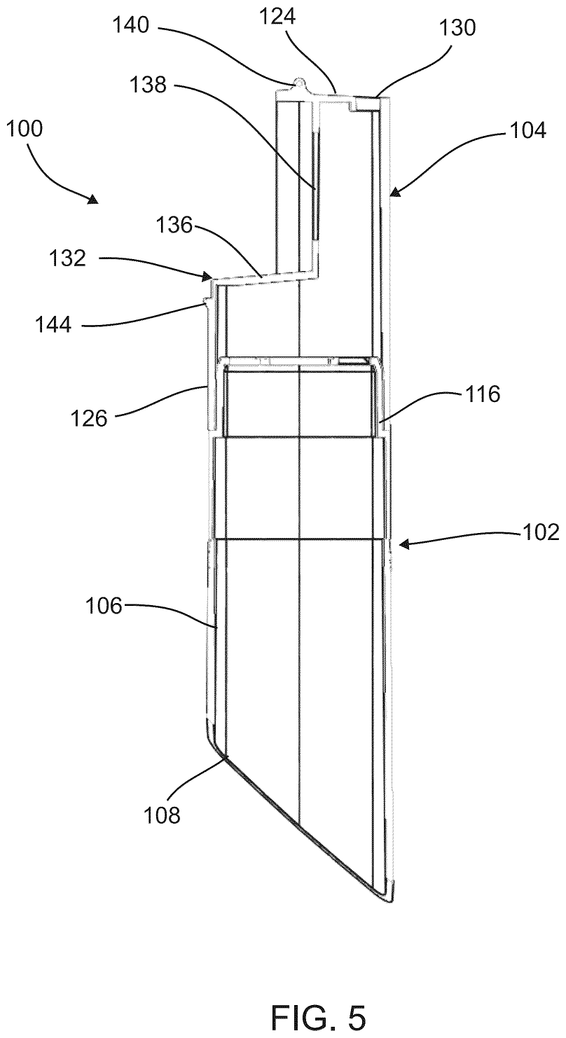

In certain configurations, the receptacle housing 104 includes a top end 124, a plurality of side walls 126 which define an interior cavity, and an open bottom as best shown in FIG. 4. The open bottom allows the receptacle housing 104 to be slidably engaged with the post 102. The top end 124 can include an aperture 130 which receives a removable cap. The cap can be threadably connected to the aperture 130. The cap can be removed to allow for conductors to be run through the top of the receptacle housing 104 or to permit attachment of an accessory such as a lighting device.

In certain configurations, the receptacle housing 104 can include a cover receiving base 132 formed integrally with one of the side walls 126. A cover can be removably connected to the base 132. The base 132 can include one or more walls 134 that are recessed from the side walls 126 of the receptacle housing 104. This recess can provide a flush mounting surface for an associated cover.

In certain configurations, the base 132 also includes a step 136 extending outwardly from an interior flange 138. The interior flange 138 can be recessed from the side walls of the base 132 and separates the interior of the receptacle housing 104 from the exterior. The flange 138 is configured to receive a receptacle and can include different openings to receive mechanical fasteners to connect different types of receptacles in different orientations. In the illustrated embodiment, the flange 138 is sized to receive a standard single-gang outlet or switch.

A hinge member 140 and a pin 142 allows for pivoting movement of the cover relative to the base 132. In the illustrated example, the pin 142 connects the cover to the base 132 at the top end 124. In other examples, the pin 142 can connect the cover to the base 132 proximate to one of the side walls 126. Changing where the cover and the base 132 are connected can change the pivoting direction of the cover relative to the base 132. In certain configurations, the cover can be a waterproof cover and can also be an in-use cover that allows the cover to be closed while one or more plugs are connected to a receptacle. Different types of receptacle covers can be used as desired. In certain configurations, a catch 144 and a first locking member 146 can be provided on or adjacent to the base 132 to help secure and if necessary lock the cover to the receptacle housing 104.

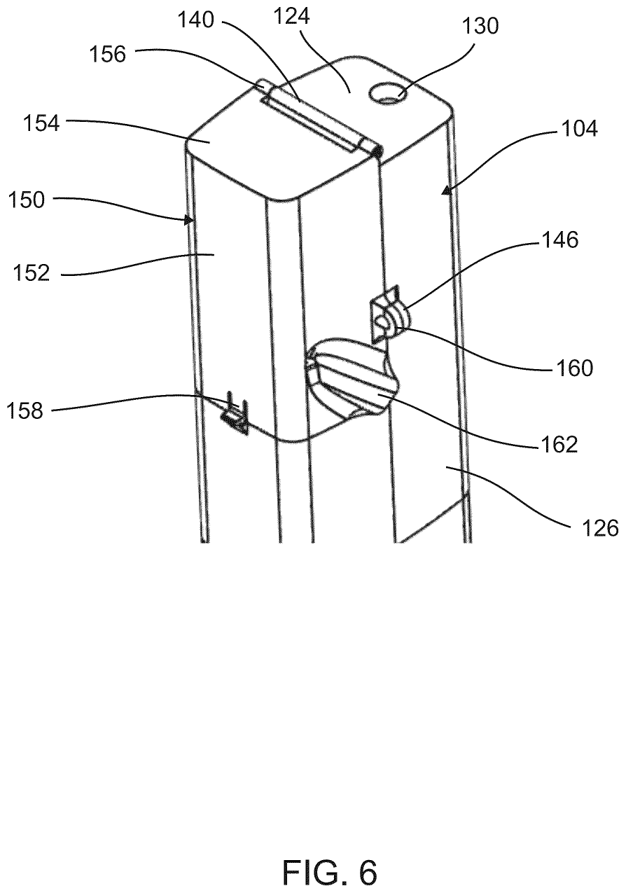

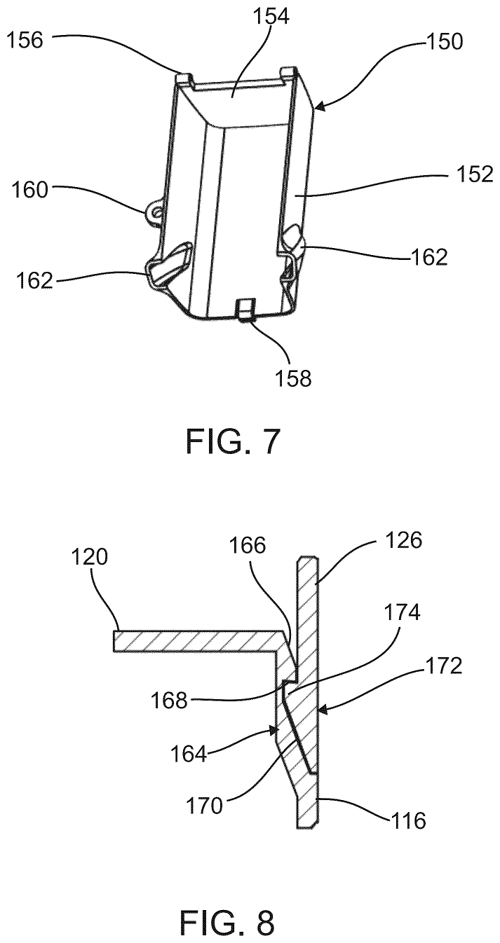

FIGS. 6 and 7 shows an exemplary embodiment of a cover 150 that can be connected to the receptacle housing 104. The cover 150 includes side walls 152 and a top wall 154. The walls 152, 154 define an interior configured to be placed over the base and provide room for a cable to run while being plugged into a receptacle.

The top wall 154 includes a hinge member 156 receiving the pin 142. The front side wall 152 can include a latch 158 that can engage the catch 144 to secure the cover 150 in the closed position. A second locking member 160 can extend from one of the side walls 152 to align with the locking member 146 of the receptacle housing 104. One or more of the side walls 152 can include a protrusion 162 defining a cable passageway. The cable passageway can allow the cable of a plug received in an outlet to pass between the cover 150 and the base 132 when the cover is in the closed position.

In certain embodiments, the receptacle housing 104 can be connected to the post 102 using a releasable connection, such as a snap fit connector. On or more snap-fit connectors can be placed on the side walls 116 of the housing receiving area of the mounting post 102 and along the side wall 126 of the receptacle housing 104. These connectors can be configured to mate with one another to releasably secure the receptacle housing 104 to the post 102. The number and position of these connectors can vary depending on the application and the environment. In some configurations, one or more connectors are positioned on one or more of the sides 116, 126. For example, one or more connectors can be positioned on each side 116, 126 or one or more connectors can be positioned on two opposing sides 116, 126 while the other sides have no connectors

FIG. 8 shows an exemplary configuration of a post connector 164 positioned on the side walls 116 of the housing receiving area. The post connector 164 can have a tapered lead-in 166, an angled upper edge 168, and a recessed area 170. The post connector 164 is configured to receive a mating receptacle housing connector 172. The housing connector 172 is positioned on a side wall 126 of the receptacle housing 104 and has a cantilevered catch 174 configured to displace outwardly along the lead-in 166 and secure to the angled upper edge 168. One or more of these connections can be positioned on one or more of the side walls 116, 126.

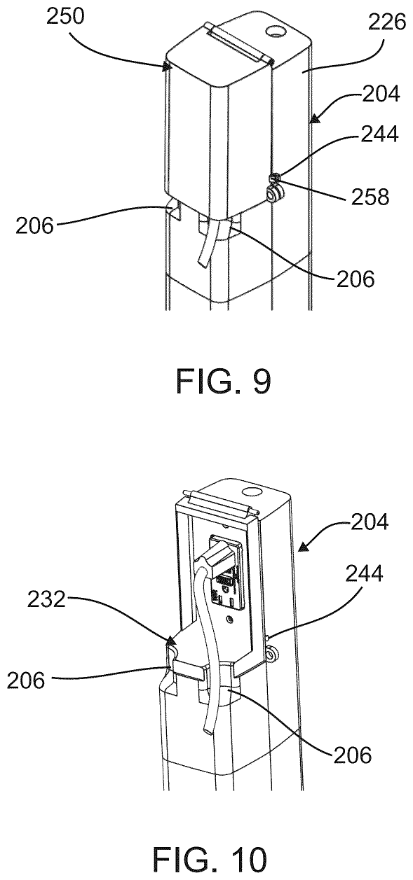

FIGS. 9 and 10 shows another configuration of a receptacle housing 204 and cover 250 that can be connected to the mounting post 102. In this embodiment, a pair of curved recessed areas 206 extend into the side walls 226 of the housing 204 and into the base 232. The curved recess area provides space for a conductor 208 of a plug to pass through the cover 250 and the base 232 when the cover 250 is in the closed position. In this embodiment, the catch 244 and the latch 258 are positioned on the side of the receptacle housing 204 and cover 250.

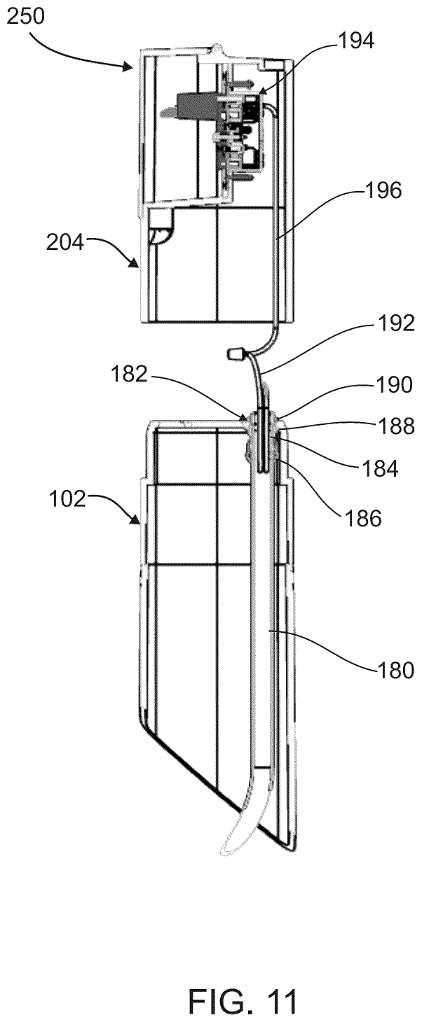

FIG. 11 shows an exemplary wiring configuration for the post 102 and the receptacle housing 204. During installation, one or more of the knockouts 122 can be removed and the mounting post 102 can be positioned over a conduit 180. The conduit 180 can have a connection assembly 182 including a threaded connector 184 having an upper section and a lower section. A compression nut 186 can be connected to the lower section to secure the connector 184 to the conduit 180. A sealing washer 188 can be connected to the threaded connector and positioned below the post upper wall 120. A locking nut 190 can be rotated onto the upper section of threaded connector 184 on the upper surface of the upper wall 120. The locking nut 190 can be tightened to secure the conduit 180 to the post 102. One or more electrical conductors 192 can extend through the conduit to supply power to an attached device.

A receptacle 194 can be wired with one or more conductors 196 prior to attaching the receptacle housing 204 to the post 102. In certain installations, the receptacle 194 can be wired before it is secured to the receptacle housing 204 so that the conductors 196 can be fed through the interior of the receptacle housing 204 prior to installation. The receptacle conductors 196 and the conduit conductors 192 can then be connected together, e.g., with wire nuts, prior to the receptacle housing 204 being placed on the post 102. This creates an easier installation method than typical outdoor posts which have a single piece construction so that the wires from the conduit must be feed out through the receptacle opening and the receptacle wired after complete installation of the post.

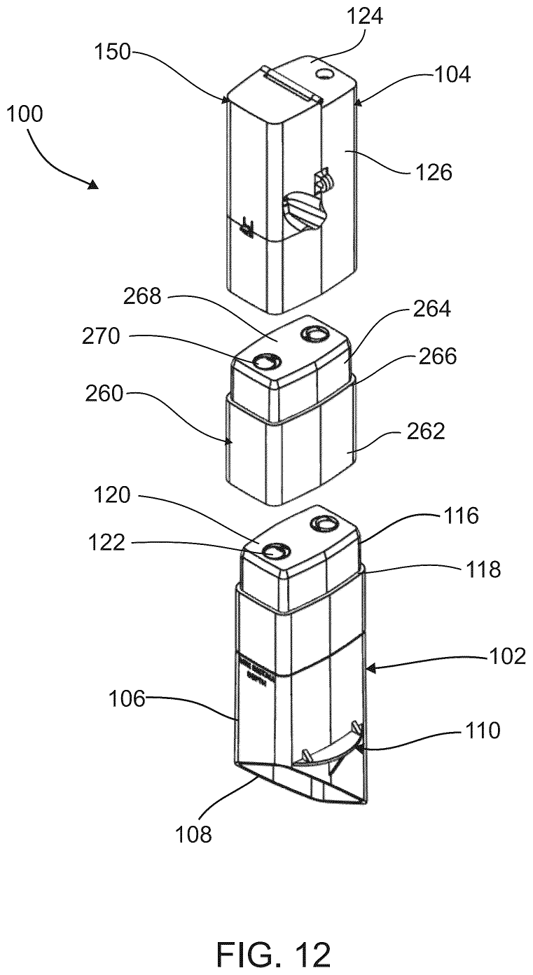

FIG. 12 shows an exemplary extension 260 that can be used with the post 102 and any of the receptacle housings. The extension 260 is configured to adjust the height of a connected receptacle housing to achieve a desired position. One or more extensions 260 can be used as needed and the length of the extensions 260 can be adjusted for different applications.

The extension 260 includes a body 262 having a lower edge and an upper portion. The lower edge is configured to rest on the edge 118 of the post 102. The upper end of the extension 260 can include a housing receiving area defined by one or more outer walls 264 offset from the lower body 262. An edge 266 is formed between the lower body 262 and the upper end. The receptacle housing can be received on the edge 266 so that an outer surface of the receptacle housing is substantially flush with an outer surface of the lower body 262. As noted above, one or more extensions 260 can also be received on the edge 266 to achieve a desired height of the receptacle housing.

An upper wall 268 of the extension 260 can include one or more knockouts 270 which can be removed to provide apertures. The knockouts 270 are configured to align with the knockouts 122 of the post 102. These apertures can be used for running conductors to make electrical connections in the receptacle housing. For example, a conduit containing one or more conductors can be positioned inside of the post 102 and the extension 260 and run through an opening formed by removal of a knockouts 122, 270. The conduit can be held in place by a fastener positioned on the outside of the upper wall 268, for example a locking nut, as shown in FIG. 11.

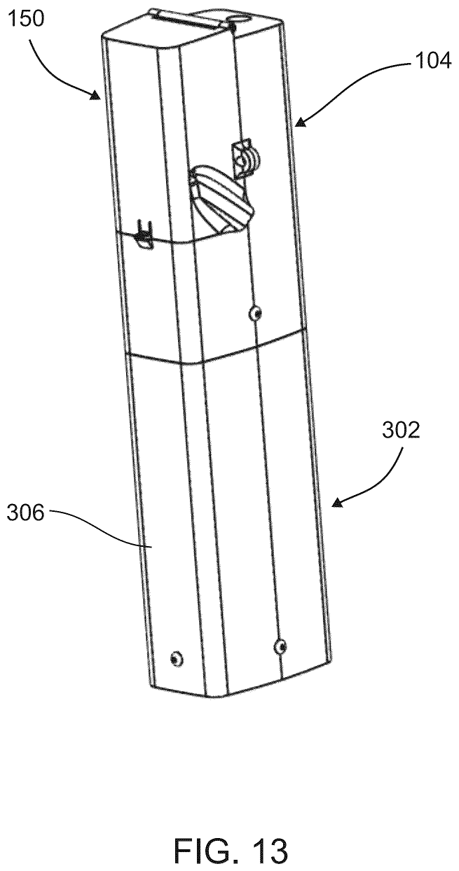

FIGS. 13-14 show an exemplary configuration of a power post assembly for an electrical device. The illustrated embodiment depicts a mounting post 302, and a removable receptacle housing 104 and cover 150 connected to the mounting post 302. Other configurations can utilize different housings or different electrical devices, such as light fixtures, connected to the mounting post 302.

In certain configurations the post 302 is a flush mounted post having a substantially hollow body 306 with a square shape having a lower end and an upper end. The lower end can connect to a mounting plate 308 that can be secured to the ground. The upper end of the post 302 can include a housing receiving area defined by one or more outer walls 316 offset from the lower body 306. An edge 318 is formed between the lower body 316 and the upper end. The receptacle housing 304 can be received on the edge 318 so that an outer surface of the receptacle housing 304 is substantially flush with an outer surface of the lower body 306.

An upper wall 320 of the post 302 can include one or more knockouts 132 which can be removed to provide apertures through the upper end of the post 302. These apertures can be used for running conductors to make electrical connections in the receptacle housing 304. For example, a conduit containing one or more conductors can be positioned inside of the post 102 and run through an opening formed by removal of a knockout 322. The conduit can be held in place by a fastener positioned on the outside of the upper wall 320, for example a locking nut.

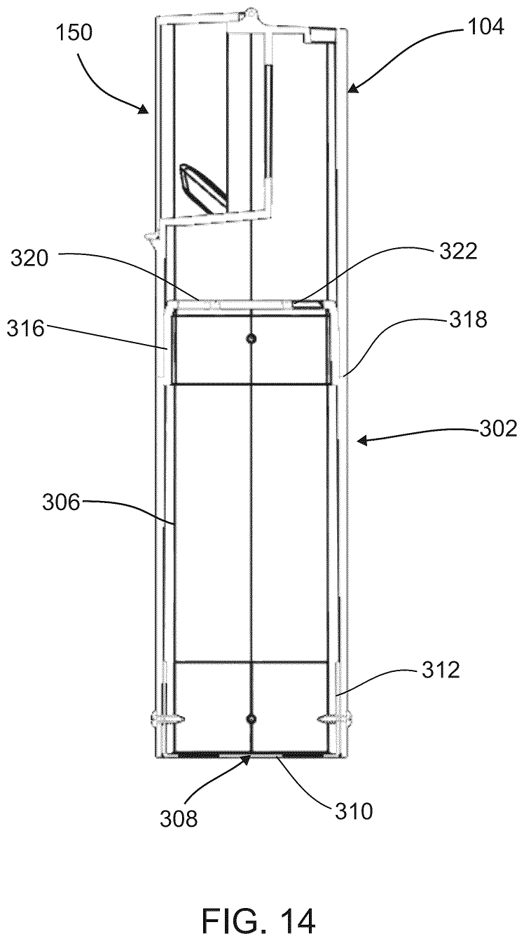

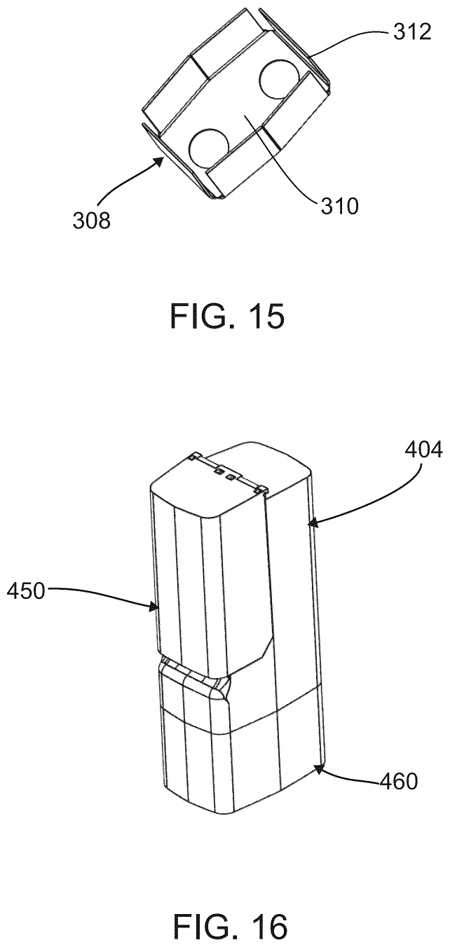

FIG. 15 shows an exemplary embodiment of the mounting plate 308 used with the flush mounting post 302. The mounting plate 308 can be connected to the ground and receive a mounting post. The mounting plate 308 includes a base 310 and one or more side walls 312 extending from the base 310. Openings are provided in the base 310 to receive a conduit. The mounting plate 308 extending into the post 302 and can be secured using one or more mechanical fasteners. As best shown in FIG. 13, mechanical fasteners can also be used to secure the receptacle housing 104 to the post 302. In other configurations, snap-fit connectors or other connections can be used.

FIG. 16 shows an exemplary embodiment of a receptacle housing 404 connected to an extension member 460. A cover 450 is moveably connected to the receptacles housing 404 and the extension member 460. One or more extensions members 460 can be used and the extension member 460 can be connected to any mounting post or other mounting structure.

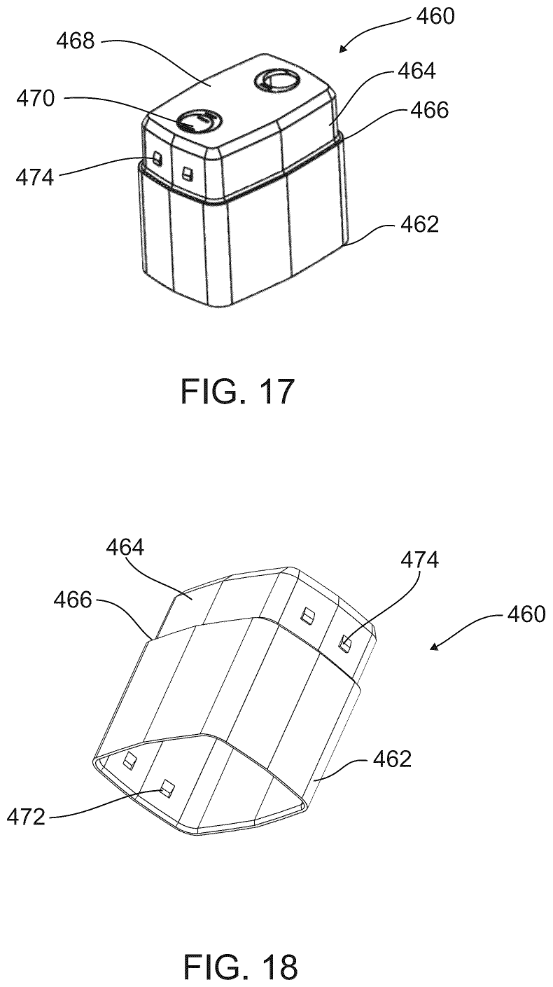

As best shown in FIGS. 17 and 18, the exemplary extension 460 includes a body 462 having a lower edge that is configured to rest on the edge of the post. The upper end of the extension 460 can include a housing receiving area defined by one or more outer walls 464 offset from the lower body 462. An edge 466 is formed between the lower body 462 and the upper end. The receptacle housing can be received on the edge 466 so that an outer surface of the receptacle housing is substantially flush with an outer surface of the lower body 462. As noted above, one or more extensions 460 can also be received on the edge 466 to achieve a desired height of the receptacle housing.

An upper wall 468 of the extension 460 can include one or more knockouts 470 which can be removed to provide apertures. These apertures can be used for running conductors to make electrical connections in the receptacle housing. For example, a conduit containing one or more conductors can be positioned inside of a post and the extension 460 and run through an opening formed by removal of a knockouts 470.

In certain configurations, the interior of the body 462 can include at least one first snap-fit connector 472 and the outer walls 464 can include at least one second snap-fit connector 474. The first snap-fit connector 472 is configured to mate with a connector on another extension 460 or on a post or other mounting structure. The second snap-fit connector 474 is configured to mate with another extension 460 or the receptacle housing 404. In some configurations, the first snap-fit connector 472 includes a female mating structure and the second snap-fit connector includes a male mating structure. In the illustrated example, a pair of first connectors 472 and a pair of second connectors 474 are formed on two opposing sides of the extension 460. These connectors 472, 474 can have the structure shown in FIG. 8. Other structures can also be used.

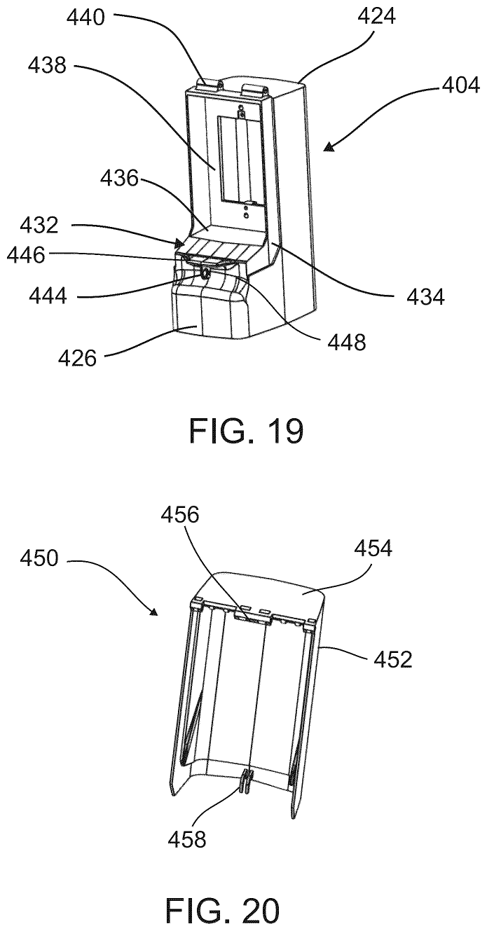

FIG. 19 shows an exemplary embodiment of the receptacle housing 404. In certain configurations, the receptacle housing 404 includes a top end 424, a plurality of side walls 426 which define an interior cavity and an open bottom. The open bottom allows the receptacle housing 404 to be slidably engaged with the extension 406 or a mounting post.

In certain configurations, the receptacle housing 404 can include a cover receiving base 432 formed integrally with one of the side walls 426. A cover can be removably connected to the base 432. The base 432 can include one or more walls 434 that are recessed from the side walls 426 of the receptacle housing 404. This recess can provide a flush mounting surface for an associated cover.

In certain configurations, the base 432 also includes a step 436 extending outwardly from an interior flange 438. The interior flange 438 can be recessed from the side walls of the base 432 and separates the interior of the receptacle housing 404 from the exterior. The flange 438 is configured to receive a receptacle and can include different openings to receive mechanical fasteners to connect different types of receptacles in different orientations. In the illustrated embodiment, the flange 438 is sized to receive a standard single-gang outlet or switch.

A hinge member 440 allows for pivoting movement of the cover relative to the base 432. In the illustrated example, the hinge member 440 connects the cover to the base 432 at the top end 424. In other examples, the hinge member 440 can connect the cover to the base 432 proximate to one of the side walls 426. Changing where the cover and the base 432 are connected can change the pivoting direction of the cover relative to the base 432. In certain configurations, the cover can be a waterproof cover and can also be an in-use cover that allows the cover to be closed while one or more plugs are connected to a receptacle. Different types of receptacle covers can be used as desired.

In certain configurations, a first locking member 444 can extend from an outer flange 446 on or adjacent to the base 432 to help secure, and if necessary, lock the cover 450 to the receptacle housing 404. A recessed area 448 is formed under the flange 446 and the base 432 to provide passage of a cable while the cover 450 is in the closed position.

FIG. 20 shows an exemplary configuration of the cover 450. The cover 450 includes side walls 452 and a top wall 454. The walls 452, 454 define an interior configured to be placed over the base 432 and provide room for a cable to run while being plugged into a receptacle.

The top wall 454 includes a hinge member 456 for receiving a hinge pin. The front side wall 452 can include a second locking member 458 extending into the interior and configured to align with the first locking member 444. The second locking member 458 includes a pair of spaced hooks configured to be positioned on either side of the opening of the first locking member 444. When the cover 450 is closed, a padlock or similar locking device can extend through the first and second locking members 444, 458 to prevent unauthorized access to the receptacle housing 404.

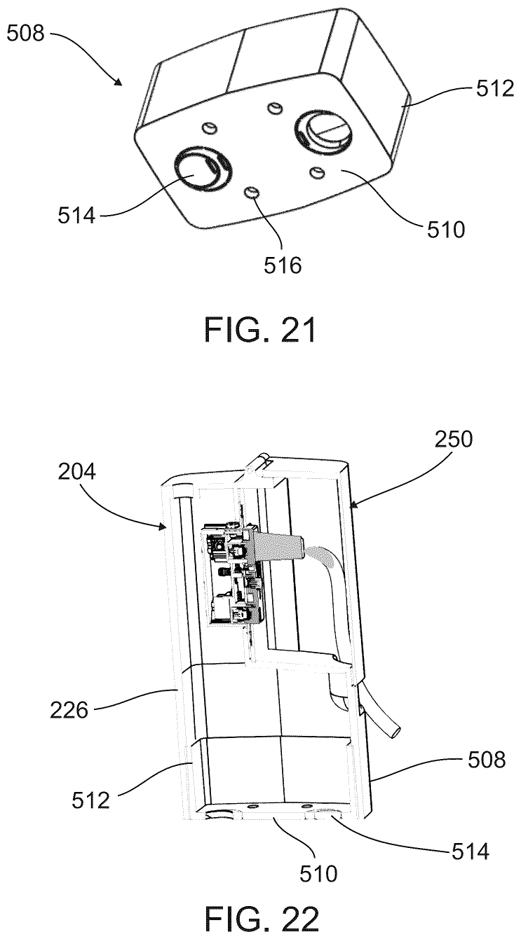

FIG. 21 shows an exemplary embodiment of a surface mounting plate 508. The mounting plate 508 includes a base 510 and one or more side walls 512 extending from the base 510. Knockouts 514 are provided in the base 510 and can be removed to receive a conduit. Apertures 516 are provided in the base 510 and can be positioned to receive fasteners to secure the mounting plate 508 to the ground or other surface.

FIG. 22 shows an exemplary configuration of the receptacle housing 204 and cover 250 connected to the mounting plate 508. The side walls 512 of the mounting plate 508 extend into the interior of the receptacle housing 204 so that the receptacle housing 204 can be mounted to a surface without a post. In other configurations, the mounting plate 508 can be used with other receptacle housings, covers, and with flush mounting posts to provide a surface mounting configuration.

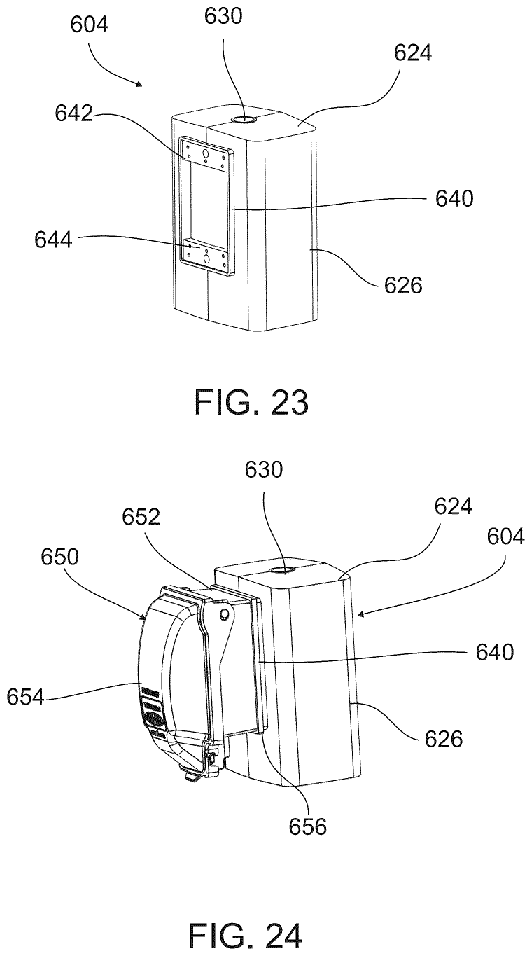

In certain exemplary embodiments, the receptacle housing can be configured to receive a weatherproof receptacle cover and receptacle, instead of directly containing the outlet itself. FIGS. 23 and 24 show an exemplary embodiment of a receptacle housing 604 configured to receive two single gang weatherproof receptacle covers 650. In certain configurations, the receptacle housing 604 includes a top end 624, a plurality of side walls 626 which define an interior cavity and an open bottom. The open bottom allows the receptacle housing 604 to be slidably engaged with a mounting post. The top end 624 can include an aperture 630 which receives a removable cap. The cap can be threadably connected to the aperture 630. The cap can be removed to allow for conductors to be run through the top of the receptacle housing 604 or to permit attachment of an accessory such as a lighting device.

The front and rear of the receptacle housing 604 can include a flange 640 surrounding and opening. An upper mounting plate 642 and a lower mounting plate 644 extend between the sides of the flange 640. Each of the mounting plates can include a plurality of openings configured to facilitate mounting of a receptacle cover 650 and a receptacle.

FIG. 24 shows an exemplary embodiment of a receptacle cover 650 connected to the receptacle housing 604. The receptacle cover 650 includes a base 652 and a lid 654 pivotally connected to the base 652. A receptacle can be mounted to the base 652 and wired to one or more conductors extending through the receptacle housing 604. The base 652 can then be connected to the upper mounting plate 642 and the lower mounting plate 644. The flange 640 can help to form a waterproof seal between the receptacle cover 650 and one or more gaskets 656 can be used between the two components.

The illustrated embodiment shows a water proof receptacle cover 650, however other types of receptacle covers, including different in-use covers, can also be used. Further, a receptacle cover 650 can be placed on either side of the receptacle housing 604, or only one side can be used and a cover plate can be placed over the remaining opening.

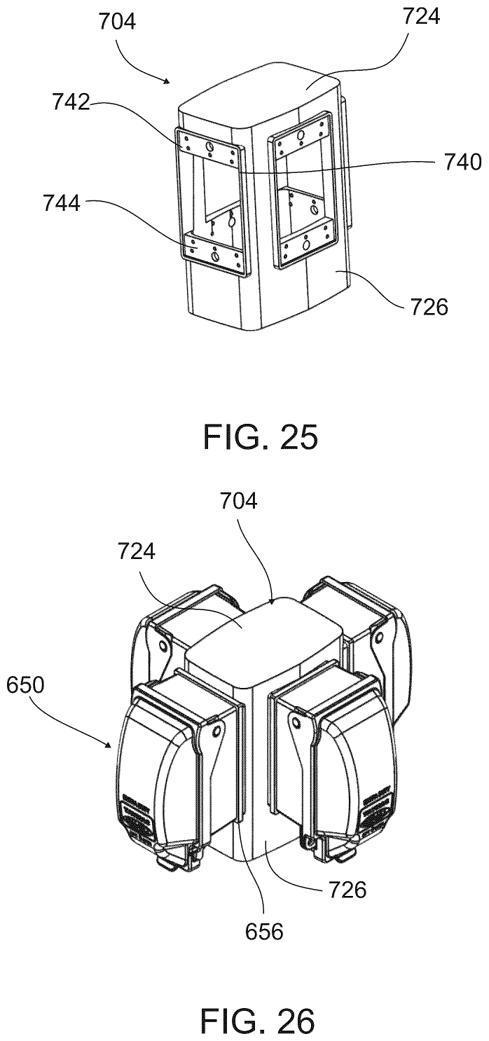

FIGS. 25 and 26 show an exemplary embodiment of an receptacle housing 704 configured to receive four single gang weatherproof receptacle covers 650. In certain configurations, the receptacle housing 704 includes a top end 724, a plurality of side walls 726 which define an interior cavity and an open bottom. The open bottom allows the receptacle housing 704 to be slidably engaged with a mounting post.

Each side of the receptacle housing can include a flange 740 surrounding and opening. An upper mounting plate 742 and a lower mounting plate 744 extend between the sides of the flange 740. Each of the mounting plates can include a plurality of openings configured to facilitate mounting of a receptacle cover 650 and a receptacle.

FIG. 26 shows an exemplary configuration of the receptacle housing 704 having four receptacle covers 650 attached. The receptacle covers 650 include a base 652 and a lid 654 pivotally connected to the base 652. A receptacle can be mounted to the base 652 and wired to one or more conductors extending through the receptacle housing 704. The base 652 can then be connected to the upper mounting plate 742 and the lower mounting plate 744. The flange 740 can help to form a waterproof seal between the receptacle cover 650 and one or more gaskets 656 can be used between the two components.

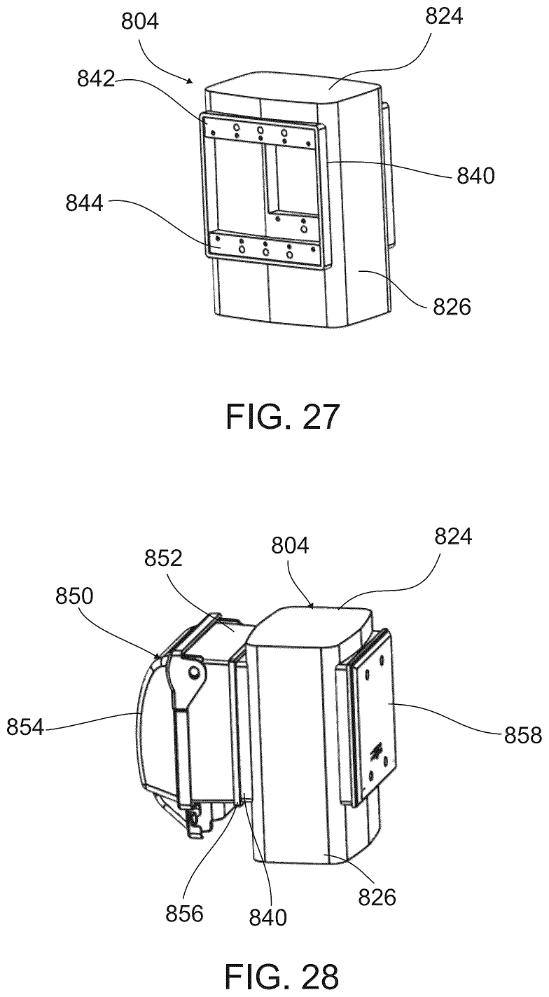

FIGS. 27 and 28 show an exemplary embodiment of an receptacle housing 804 configured to receive two, dual-gang weatherproof receptacle covers 850. In certain configurations, the receptacle housing 804 includes a top end 824, a plurality of side walls 826 which define an interior cavity and an open bottom. The open bottom allows the receptacle housing 804 to be slidably engaged with a mounting post.

The front and rear of the receptacle housing can include a flange 840 surrounding and opening. An upper mounting plate 842 and a lower mounting plate 844 extend between the sides of the flange 840. Each of the mounting plates can include a plurality of openings configured to facilitate mounting of a receptacle cover 750 and a receptacle.

FIG. 28 shows an exemplary embodiment of a receptacle cover 850 connected to the receptacle housing 804. The receptacle cover 850 includes a base 852 and a lid 854 pivotally connected to the base 852. A receptacle can be mounted to the base 852 and wired to one or more conductors extending through the receptacle housing 804. The base 852 can then be connected to the upper mounting plate 842 and the lower mounting plate 844. The flange 840 can help to form a waterproof seal between the receptacle cover 850 and one or more gaskets 856 can be used between the two components.

The illustrated embodiment shows a water proof receptacle cover 850, however other types of receptacle covers, including different in-use covers, can also be used. Further, a receptacle cover 850 can be placed on either side of the receptacle housing 804, or only one side can be used and a cover plate 858 can be placed over the remaining opening.

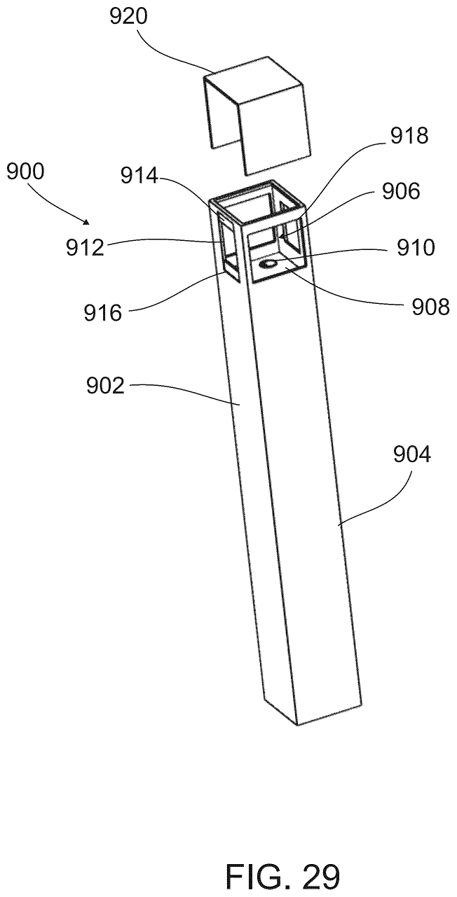

In certain exemplary embodiments, receptacles can be connected directly to a support structure that provides ample space to make a wired connection. FIG. 29 shows an exemplary configuration of a direct wire mounting post assembly 900. The mounting post assembly 900 includes a post body 902 having a plurality of side walls 904 with a lower section at least partially defining an interior and an upper section defining a receptacle receiving area 906. An upper wall 908 can extend above the interior. The upper wall 908 can include one or more knockouts 910 which can be removed to provide apertures through the upper wall 908. These apertures can be used for running conductors to make electrical connections in the receptacle receiving area 906. For example, a conduit containing one or more conductors can be positioned inside of the post 902 and run through an opening formed by removal of a knockout 910.

The receptacle receiving area 906 can be at least partially defined by openings formed in the side walls 904. In certain configurations a pair of receptacle openings 912 are formed opposite one another. Each of the receptacles openings 912 can be bound by an upper mounting plate 914 and a lower mounting plate 916. The upper and lower mounting plates 914, 916 are configured to receive a receptacle, and can include one or more openings for receiving a fastener to secure a receptacle.

A pair of access openings 918 are positioned opposite one another and between the receptacle openings 912. In certain configuration, the access openings 918 are larger than the receptacle openings 912 to provide more space for an installer to make the necessary electrical connections to the receptacles. In some configurations, one access opening 918 can be provided with three receptacle openings 912.

In certain embodiments a cover 920 is provided that fits over the top of the post body 902 to cover at least a portion of the receptacle receiving area 906. The cover 920 can have a substantially U-shaped configuration with an upper portion that covers the open top of the post body 902 and a pair of sides that cover the access openings 918. The cover 920 can be releasably connected to the post body 902 using one or more fasteners, such as screws, bolts, or snap-fit connectors.

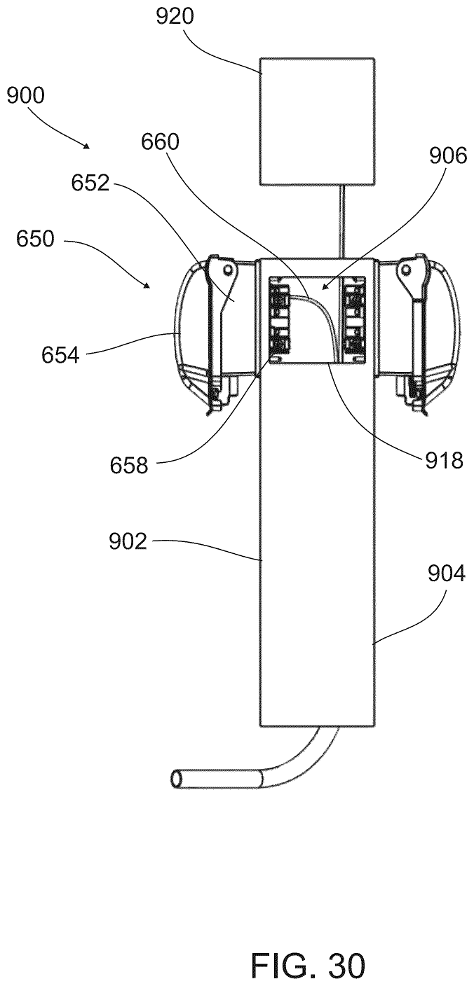

FIG. 30 shows an exemplary embodiment of a pair of receptacle covers 650 connected to the post body 902. The receptacle covers 650 include a base 652 and a lid 654 pivotally connected to the base 652. A receptacle 658 can be mounted to the base 652 and extend into the receptacle receiving area 906. The receptacles 658 are wired to one or more conductors 660 extending through the post body 902 and into the receptacle receiving area 906. The access openings 918 provide a larger space for a user to connect receptacle 658 to the conductors 660 to electrically connect the receptacle 658.

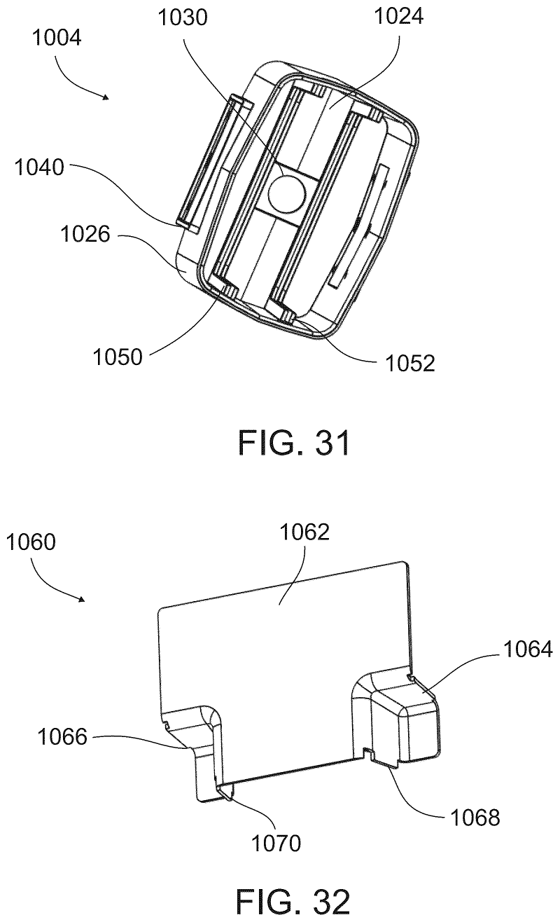

FIG. 31 shows an exemplary embodiment of a receptacle housing 1004 having a similar configuration to the receptacle housing 604 shown in FIGS. 23 and 24. The receptacle housing 1004 configured to receive two single gang weatherproof receptacle covers 650. In certain configurations, the receptacle housing 1004 includes a top end 1024, a plurality of side walls 1026 which define an interior cavity and an open bottom. The open bottom allows the receptacle housing 1004 to be slidably engaged with a mounting post. The top end 1024 can include an aperture 1030 which receives a removable cap. The cap can be threadably connected to the aperture 1030. The cap can be removed to allow for conductors to be run through the top of the receptacle housing 604 or to permit attachment of an accessory such as a lighting device.

The front and rear of the receptacle housing 1004 can include a flange 1040 surrounding and opening. An upper mounting plate and a lower mounting plate extend between the sides of the flange 104. Each of the mounting plates can include a plurality of openings configured to facilitate mounting of a receptacle cover 650 and a receptacle.

The interior of the receptacle housing 1004 can include one or more first rails 1050 and one or more second rails 1052. In the illustrated configuration the first and second rails 1050, 1052 each have a substantially U-shaped configuration running along an interior of a first side 1026, the top 1024, and a second side 1026. Other configurations can also be used, including opposing rails placed just on the sides 1026. The first and second rails 1050, 1052 at least partially define slots that are configured to receive a divider plate. The divider plate can separate the interior of the receptacles housing 1004 to provide a voltage divider. This can allow high and low voltages to be used in separate compartments of the interior as desired.

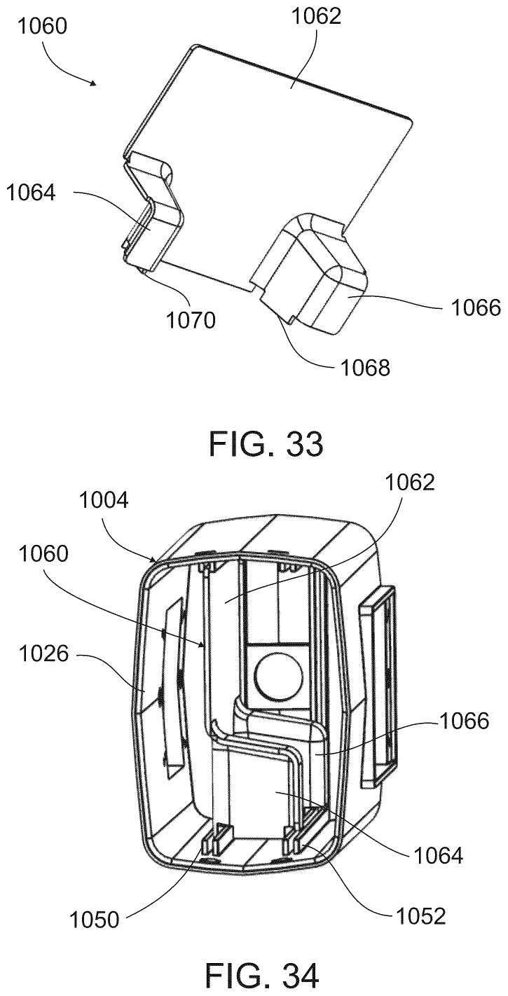

FIGS. 32 and 33 show an exemplary embodiment of a divider 1060. The divider 1060 includes a main body 1062 having a top edge and a bottom edge, a first offset 1064, and a second offset 1066. The first and second offsets 1064, 1066 extend from the main body 1062, having a plurality of outer walls. A first tab 1068 can extend from the first offset 1064 and a second tab 1070 can extend from the second offset 1066. The top and bottom edge of the main body can be received in one of the rails 1050, 1052. The first and second tabs 1068, 1070 can extend between the rails 1050, 1052 to slidably engage and secure the divider 1060 in the interior of the receptacle housing 1004.

FIG. 34 shows the divider 1060 positioned in the receptacle housing 1004. As shown, the main body portion 1062 is positioned in opposing sides of the first rails 150 and the tabs 1068, 1070 extending between the rails 1050, 1052. The divider can be oriented in either direction, i.e., reversed so that the main body 1062 is positioned in opposing sides of the second rails 1052. The divider can also be flipped so that the top and bottom edges of the main body 1062 are switched and placed in opposing sides of the first or second rails 1050, 1052. By placing the divider in different orientations, different voltage lines can be run from the different conduit opens to either receptacle opening as needed. A similar configuration having a divider can be used with other receptacle housings, including a quad single gang receptacle housings and double gang receptacle housings.

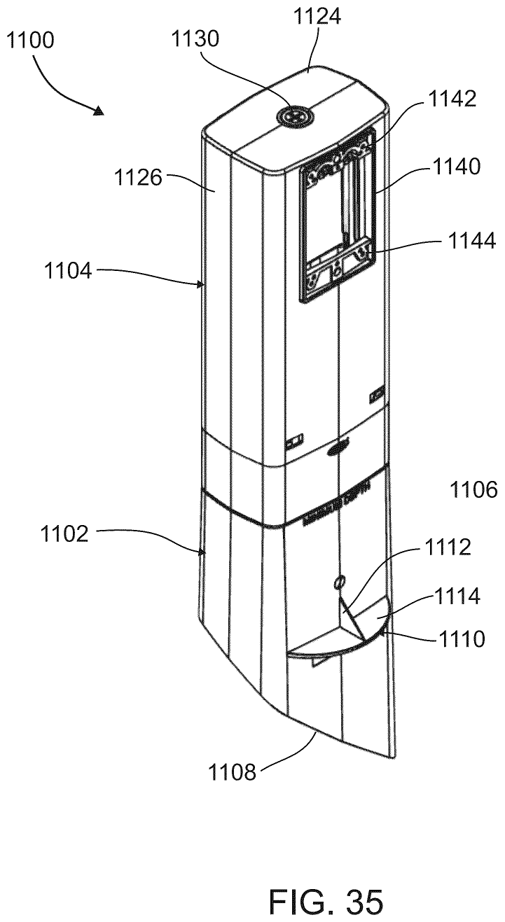

FIG. 35 shows an exemplary configuration of a power post assembly 1100 for an electrical device. The power post assembly 1100 includes a mounting post 1102 and a removable receptacle housing 1104 connected to the mounting post 1102. Other configurations can utilize different housings or different electrical devices, such as light fixtures, connected to the mounting post 1102.

In certain configurations the post 1102 is a ground-insertion post having a substantially hollow body 1106 with a square shape having a lower end and an upper end. The lower end can have a truncated portion 1108 that tapers to a point to help facilitate insertion of the post 1102 into the ground. One or more stabilizer fins 1110 can extend outwardly from the lower end. The stabilizer fins 1110 can have any combination and number of upper and lower support ribs 1112 connected to a curved flange 1114. In other configurations different types of ground stabilizers can be used instead of, or in addition to, the stabilizer fins 1110, or no stabilizers can be used.

The receptacle housing 1104 includes a top end 1124, a plurality of side walls 1126 which define an interior cavity and an open bottom. The open bottom allows the receptacle housing 1104 to be slidably engaged with the mounting post 1102. The top end 1124 can include an aperture which receives a removable cap 1130. The cap 1130 can be threadably connected to the aperture. The cap 1130 can be removed to allow for conductors to be run through the top of the receptacle housing 1104 or to permit attachment of an accessory such as a lighting device.

The front and rear of the receptacle housing 1104 can include a flange 1140 surrounding and opening. An upper mounting plate 1142 and a lower mounting plate 1144 extend between the sides of the flange 1140. Each of the mounting plates can include a plurality of openings configured to facilitate mounting of a receptacle cover and a receptacle.

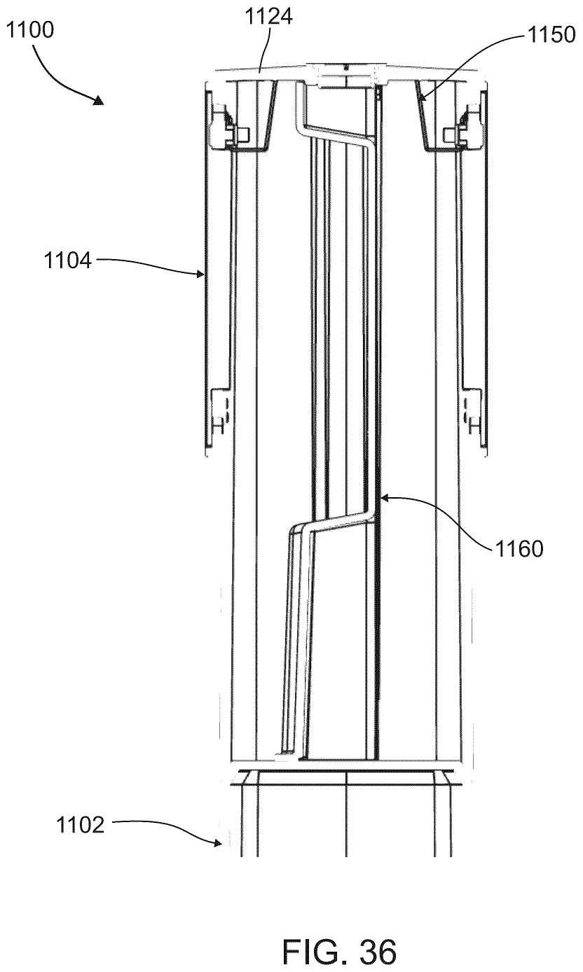

FIG. 36 shows an exemplary configuration of the interior of the receptacle housing including a grounding assembly 1150 and a divider plate 1160. The grounding assembly 1150 can extend between the two receptacle openings over the divider plate 1160. The divider plate 1160 is positioned on an upper surface of the mounting post 1102 and extends toward the top end 1124 of the receptacle housing 1104.

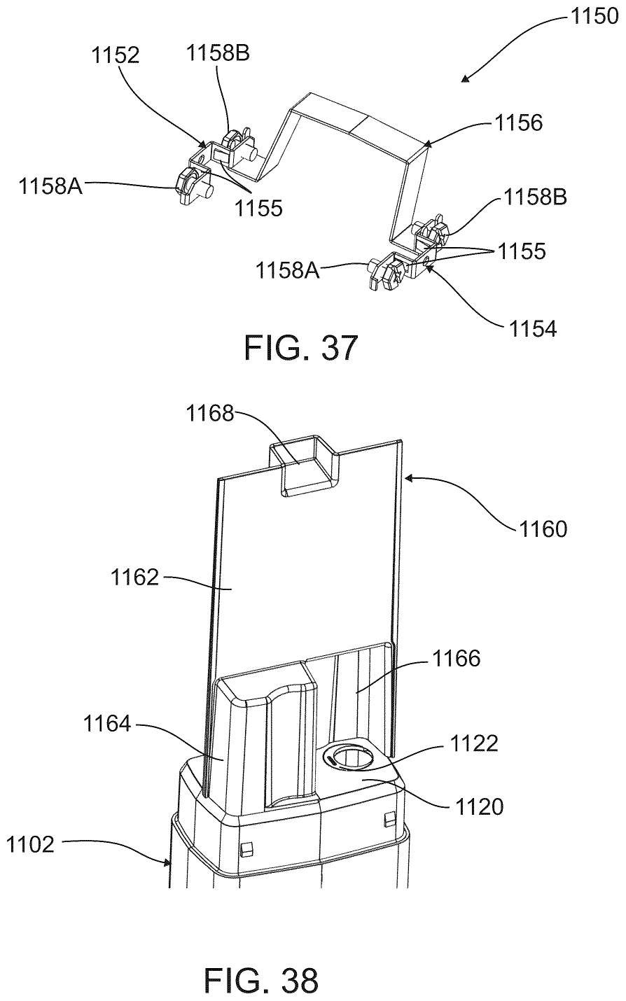

As best shown in FIG. 37, the grounding assembly 1150 can include a first mounting strap 1152 and a second mounting strap 1154 connected by a bridge 1156. The first and second mounting straps 1152, 1154 includes a first aperture configured to receive a first grounding screw 1158A and a second aperture configured to receive a second grounding screw 1158B. The mounting straps 1152, 1154 can each include a set of tines 1155 configured to snap fit to the upper mounting plate 1142. The bridge 1156 can include a C-shaped section that extends over the divider 1160.

The divider 1160 can include a main body 1162 having a top edge and a bottom edge, a first offset 1164, and a second offset 1166. An upper compartment 1168 is formed in an upper portion of the main body 1162. The upper compartment 1168 can be aligned with the cap 1130 and the aperture to allow one or more conductors to pass through the compartment and the aperture.

The first and second offsets 1164, 1166 extend from the main body 1162, having a plurality of outer walls. In the illustrated configuration, the first and second offsets 1164, 1166 extend from opposite sides of the main body 1162. The outer walls of the first and second offsets 1164, 1166 can be configured to support the divider 1160 on the upper wall 1120 of the mounting post 1102. The first and second offsets 1164, 1166 are configured to align with the one or more knockouts 1122 formed on the upper wall 1120 of the post 1102 to permit passage of power conductors or other cabling as needed.

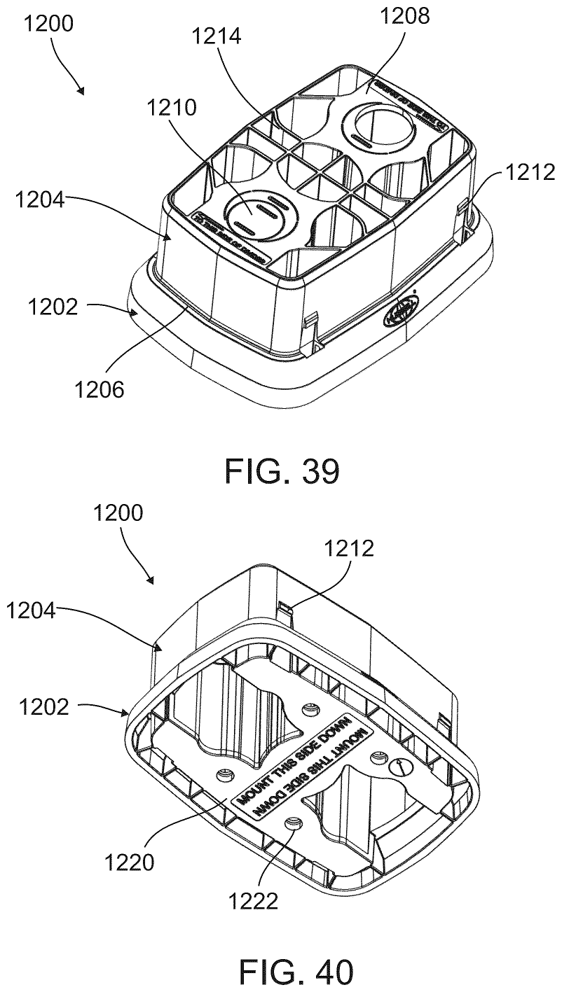

FIGS. 39 and 40 show an exemplary configuration of a surface mounting post 1200. The surface mounting post 1200 can be used in place of a ground insertion mounting post to secure a receptacle housing to the ground. The surface mounting post 1200 can include a base 1202 and a set of outer walls 1204 extending from the base 1204. An edge 1206 is formed at an upper edge of the base 1202 to receive a housing, extension, or other structure. In certain configurations, a receptacle housing can be received on the edge 1206 so that an outer surface of the receptacle housing is substantially flush with the base 1202.

An upper wall 1208 of the surface mounting post 1200 can include one or more knockouts 1210 which can be removed to provide apertures. These apertures can be used for running conductors to make electrical connections in the receptacle housing. For example, a conduit containing one or more conductors can be positioned inside of the surface mounting post 1200 and run through an opening formed by removal of a knockouts 1210.

In certain configurations, the outer walls 1204 can include at least one snap-fit connector 1212. The snap-fit connector 1212 is configured to mate with a connector on another extension, post, receptacle housing, or other mounting structure. In some configurations, the snap-fit connector 1212 includes a male mating structure, for example a deflectable hook member, configured to be received in a female mating structure, for example a slot. One or more ribs 1214 can also inside of the outer walls 1204 to provide additional support to the surface mounting post 1200.

As best shown in FIG. 40, a lower surface of the surface mounting post 1200 can include a mounting plate 1220. The mounting plate 1220 includes a plurality of apertures 1222 configured to receive a fastener, such as a bolt or screw, to secure the surface mounting post 1200 to a surface. For example, bolts or screws can be driven into the ground and the surface mounting post 1200 can be positioned so that the shafts of the fasteners extend through the apertures 1222. The apertures 1222 can be accessible to a user through the upper wall 1208 so that other components of the fastener, for example a nut, can be installed and accessed by a user.

The various exemplary configurations for posts, mounting plates, and receptacle housings described are configured to be modular so that they can be grouped together in any combination. Additional configurations of posts, mounting plates, and receptacle housings can also be used in combination with those described. Forming these different combinations allows them to be used in different environments as needed.

The foregoing detailed description of the certain exemplary embodiments has been provided for the purpose of explaining the general principles and practical application, thereby enabling others skilled in the art to understand the disclosure for various embodiments and with various modifications as are suited to the particular use contemplated. This description is not necessarily intended to be exhaustive or to limit the disclosure to the exemplary embodiments disclosed. Any of the embodiments and/or elements disclosed herein may be combined with one another to form various additional embodiments not specifically disclosed. Accordingly, additional embodiments are possible and are intended to be encompassed within this specification and the scope of the appended claims. The specification describes specific examples to accomplish a more general goal that may be accomplished in another way.

As used in this application, the terms “front,” “rear,” “upper,” “lower,” “upwardly,” “downwardly,” and other orientational descriptors are intended to facilitate the description of the exemplary embodiments of the present disclosure, and are not intended to limit the structure of the exemplary embodiments of the present disclosure to any particular position or orientation. Terms of degree, such as “substantially” or “approximately” are understood by those of ordinary skill to refer to reasonable ranges outside of the given value, for example, general tolerances associated with manufacturing, assembly, and use of the described embodiments. Unless specified or limited otherwise, the terms “mounted,” “connected,” “supported,” and “coupled” and variations thereof are used broadly and encompass both direct and indirect mountings, connections, supports, and couplings.

What is claimed:

1. An outdoor mounting assembly for an electrical device comprising:
a post having a hollow body with an upper end and a lower end;
a receptacle housing removably connected to the upper end of the post, the receptacle housing having a top and a plurality of side walls defining an interior cavity, at least one of the side walls having an opening providing access to the interior cavity;
a cover moveably connected to the receptacle housing, the cover having an opening to permit passage of a conductor.

2. The outdoor mounting assembly for an electrical device of claim 1, wherein the receptacle housing includes a base extending from the opening.

3. The outdoor mounting assembly for an electrical device of claim 1, wherein the receptacle housing includes a hinge member to receive the cover.

4. The outdoor mounting assembly for an electrical device of claim 1, wherein a stabilizer fin is connected to the lower end of the post.

5. The outdoor mounting assembly for an electrical device of claim 1, wherein a locking member extends from a sidewall of the receptacle housing.

6. The outdoor mounting assembly for an electrical device of claim 1, wherein the post includes one or more recessed outer surfaces bounded by an edge for receiving the receptacle housing.

7. The outdoor mounting assembly for an electrical device of claim 1, wherein the post includes an upper surface with one or more knockouts.

8. The outdoor mounting assembly for an electrical device of claim 1, wherein the post includes a first snap-fit connector and the receptacle housing includes a second snap-fit connector configured to mate with the first snap-fit connector.

9. The outdoor mounting assembly of claim 1, wherein the receptacle housing has a recessed area configured to receive a conductor connected to a receptacle.

10. The outdoor mounting assembly of claim 1, wherein an extension is positioned between the post and the receptacle housing.

11. The outdoor mounting assembly of claim 1, wherein a divider is positioned inside of the receptacle housing.

12. The outdoor mounting assembly of claim 1, wherein the receptacle housing includes a flange extending around the opening, an upper mounting plate, and a lower mounting plate.

13. An outdoor mounting assembly for an electrical device comprising:
a post having a hollow body with an upper end and a lower end;
a receptacle housing removably connected to the upper end of the post, the receptacle housing having a top and a plurality of side walls defining an interior cavity, at least one of the side walls having an opening providing access to the interior cavity; and
a divider removably positioned in the interior cavity of the receptacle housing to separate the interior cavity into a first compartment and a second compartment.

14. The outdoor mounting assembly of claim 13, wherein the receptacle housing includes a rail for receiving the divider.

15. The outdoor mounting assembly of claim 13, wherein the divider is configured to be positioned on the post.

16. The outdoor mounting assembly of claim 13, wherein the divider includes a main body, a first offset extending outwardly form the main body, and a second offset extending outwardly from the main body.

17. The outdoor mounting assembly of claim 16, wherein the first offset extends opposite the second offset.

18. The outdoor mounting assembly of claim 13, wherein the post is a surface mounting post.

19. A method of connecting a receptacle to an outdoor mounting assembly comprising:
positioning a post to receive a conduit containing a primary electrical conductor and to extend above a support surface;
connecting a receptacle to a receptacle housing;
connecting a secondary electrical conductor to the receptacle;
positioning the receptacle housing near the post and connecting the primary electrical conductor with the secondary electrical conductor; and
positioning the receptacle housing on the post after connecting the primary electrical conductor with the secondary electrical conductor.

20. The outdoor mounting assembly of claim 19, further comprising positioning a divider in the receptacle housing.
